(19) United States
(12) Patent Application Publication
(10) Pub. No.: US 2005/0055208 A1
(43) Pub. Date: Mar. 10, 2005

(54) Method and apparatus for fast calculation of observation probabilities in speech recognition

(76) Inventors: Alexandr A. Kibkalo, Sarov (RU); Vyacheslav A. Barannikov, Sarov (RU)

Correspondence Address: INTEL/BLAKELY, 12400 WILSHIRE BOULEVARD, SEVENTH FLOOR, LOS ANGELES, CA, 90025-1030, US

(21) Appl. No.: 10/482,397

(22) PCT Filed: Jul. 3, 2001
(86) PCT No.: PCT/RU01/00263

(51) Int. Cl. G10L 15/00

(52) U.S. Cl. 704/255

(57) ABSTRACT

A method is presented that calculates many active mixture functions in a vector using single instruction multiple data (SIMD) instructions to process the vector. The vector contents are stored in a memory (110). The vector contents are used for speech recognition. Also presented is a device that includes a processor (210). A memory (110) is connected to the processor (210). A fast speech recognition process is connected to the processor (210) and the memory (110). The fast speech recognition process uses single instruction multiple data (SIMI) instructions to process a vector.

### BACKGROUND OF THE INVENTION

1. Field of the Invention

This invention relates to speech recognition, and more particularly to a method and apparatus for vector calculations of observation probabilities.

2. Description of the Related Art

In today's speech recognition systems, calculation of acoustic probability takes a substantial amount of processing power in computers. In many computer systems, this can add up to as much as eighty percent. Typically, Gaussian mixture density functions are used to calculate acoustic probabilities. One abstraction to the acoustic probability calculation is that a number of relevant mixture values (known as “active” mixtures) are calculated for each moment of time (or frame).

The Gaussian mixture density function typically has the following form:

$$G ( X , \overline{μ} , {\overline{\sum }}^{} , n ) = {\sum }_{i = 0}^{n - 1} {( 2 π )}^{- d / 2} {\vert {\sum }_{i}^{} \vert}^{1 / 2} exp [ - \frac{1}{2} {( X - {μ}_{i} )}^{T} {\sum }_{i}^{- 1} ( X - {μ}_{i} ) ]$$

where n is the number of mixture components, μᵢ are the mean vectors, and Σᵢ are the covariance matrices (typically diagonal). Traditional means for accelerating the acoustic probability calculation focus on reducing the active mixture component number for each frame. Component choice, pruning methods and caching methods have been developed to try to achieve this goal. These methods, however, complicate the recognizer function and introduce additional bookkeeping cost in terms of memory and processing bandwidth.

### BRIEF DESCRIPTION OF THE DRAWINGS

The invention is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

FIG. 1 illustrates a typical speech recognition system.

FIG. 2 illustrates an embodiment of the invention having a fast calculation speech recognition process in a system.

FIG. 3 illustrates a block diagram for an embodiment of the invention.

FIG. 4 illustrates pseudo-code for an embodiment of the invention having a fast calculation speech recognition process that takes advantage of single instruction multiple data (SIMD) instructions.

FIG. 5 illustrates a comparison between a traditional approach and an embodiment of the invention having fast calculation speech recognition process using SIMD instructions.

FIG. 6 illustrates results from using embodiments of the invention having a fast calculation speech recognition process using SIMD instructions.

### DETAILED DESCRIPTION OF THE INVENTION

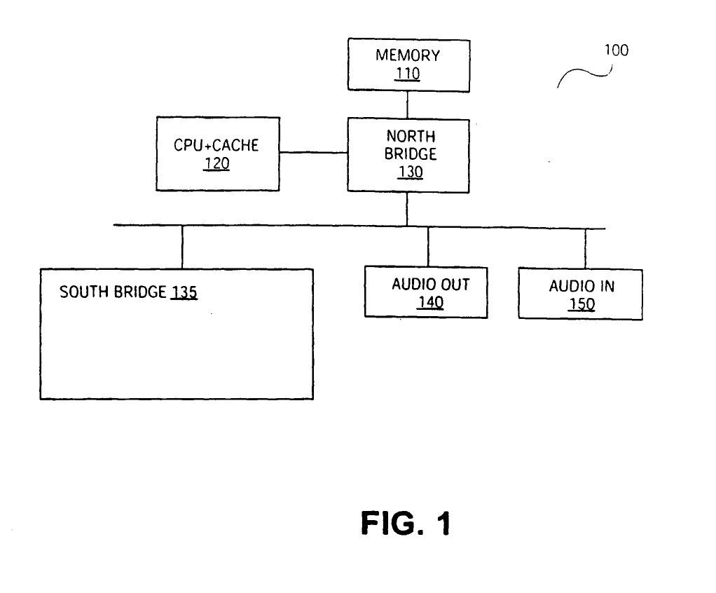

The invention generally relates to a method and apparatus for fast calculation of observation probabilities in speech recognition using vectors. Referring to the figures, exemplary embodiments of the invention will now be described. The exemplary embodiments are provided to illustrate the invention and should not be construed as limiting the scope of the invention. FIG. 1 illustrates a typical computer system that can be used for speech recognition comprising memory 110, central processing unit (CPU) 120, north bridge 130, south bridge 135, audio-out device 140, and audio-in device 150. Audio-out device 140 may be a device such as a speaker system. Audio-in device 150 may be a device such as a microphone.

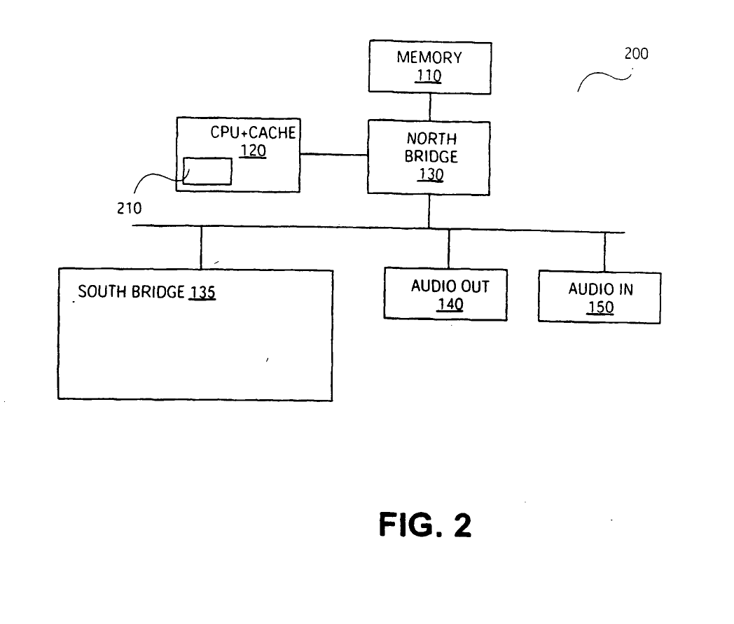

FIG. 2 illustrates system 200 having an embodiment of the invention incorporating fast calculation speech recognition process 210. In one embodiment of the invention, fast calculation speech recognition process 210 uses single instruction multiple data (SIMD) instructions. In this embodiment of the invention, the SIMD instructions use multimedia extensions (MMX), technology, streaming SIMD instructions (SSX) (also known as MMXII technology). It should be noted that MMX instructions were initially conceived for the purpose of speeding up multimedia applications, especially in the area of audio and video compression and decompression algorithms that are implemented in software. In a SIMD architecture, one instruction performs the same operation on multiple data elements in parallel.

In one embodiment of the invention, acoustic probability calculations are performed for all active mixtures. In this embodiment of the invention, SIMD implementation increases efficiency in calculating elements of probability values in vectors. In this embodiment of the invention, some calculations are unused, however, overall speed is increased over typical approaches that calculate each acoustic probability individually. In one embodiment of the invention, streamlining SIMD extensions (SSE) and SSE-2 extensions are implemented. One should note that future modifications/adaptations/additions to SIMD, SSE, and SSE-2 extensions are also applicable to embodiments of the invention.

In one embodiment of the invention, acoustic probabilities are calculated once for a few successive frames to further take advantage of the vector implementation since it is observed that mixture components tend to remain active during recognition.

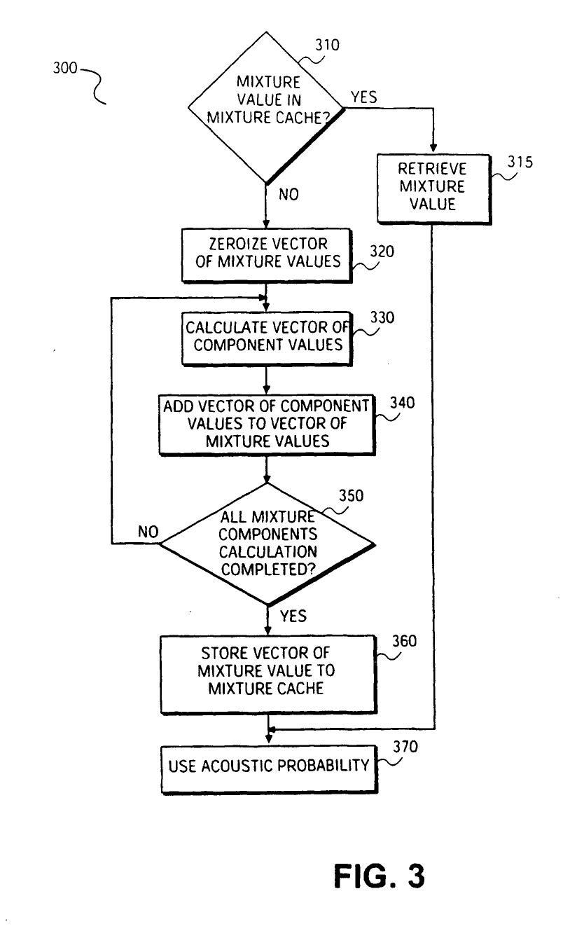

FIG. 3 illustrates an embodiment of the invention having a fast calculation speech recognition process 300 that takes advantage of SIMD instructions. Process 300 begins with block 310, which determines whether mixture values are in cache memory (mixture cache). In one embodiment of the invention, the cache memory (mixture cache) can be either a physical cache memory or a software implemented cache memory. In an embodiment of the invention where the cache memory is a software-implemented cache memory, the cache memory is controllable by a user or the speech recognition system. That is, the amount of software cache memory allocated is modifiable. If block 310 does determine that mixture values are in cache memory, then process 300 continues with block 315, which retrieves the mixture value from the cache memory. If block 310 determines that a mixture value is not in cache memory, then process 300 continues with block 320.

Block 320 zeroizes a vector of mixture values. Process 300 continues with block 330, which calculates the vector of component values. Process 300 continues with block 340, which adds the vector of component values to the vector of mixture values. Once block 340 is completed, process 300 continues with block 350. Block 350 determines whether all the mixture component calculations have been completed. If the mixture component calculations are not completed, process 300 continues with block 330. If block 350 determines that all the mixture component calculations are completed, process 300 continues with block 360, which stores the vector of mixture values to cache memory (mixture cache).

Once block 360 has completed, or block 315 has completed, process 300 continues with block 370, wherein the acoustic probability is ready for use in a system, such as system 200.

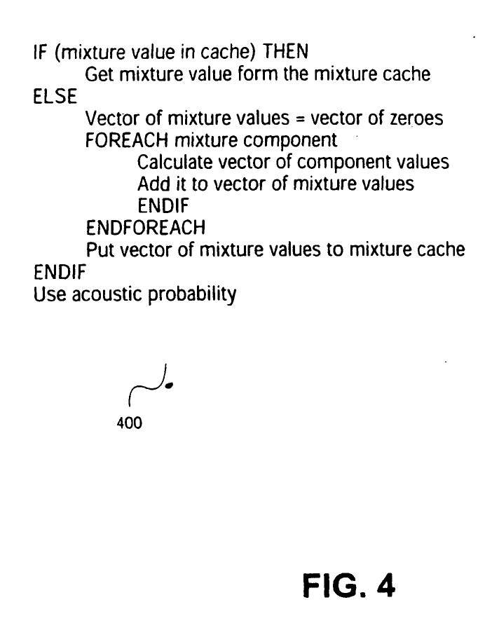

FIG. 4 illustrates pseudo code 400 for an embodiment of the invention having a fast calculation speech recognition process.

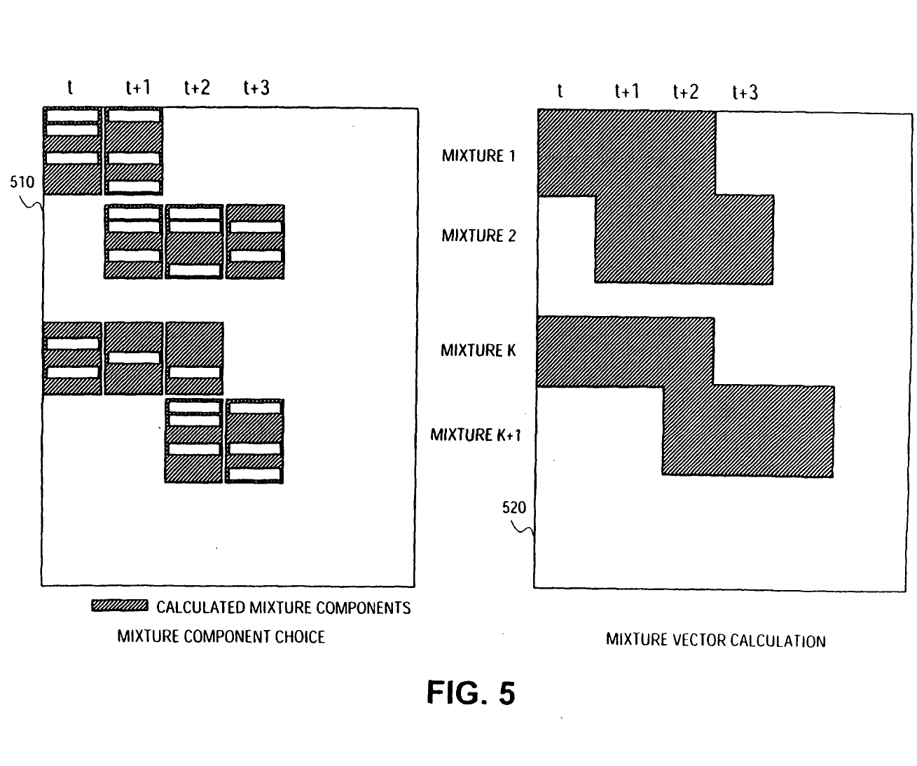

FIG. 5 illustrates a comparison between a traditional approach 510, and an embodiment of the invention having fast calculation speech recognition process 210 that uses SIMD instructions, illustrated by 320. The traditional approach 510 calculates individual mixture component probabilities for each frame. In one embodiment of the invention, a mixture vector calculation calculates all mixture components at once for successive frames, the result is illustrated by 520. By using a vector calculation (via SIMD instructions), calculation of all mixture components is completed much faster than in the prior art.

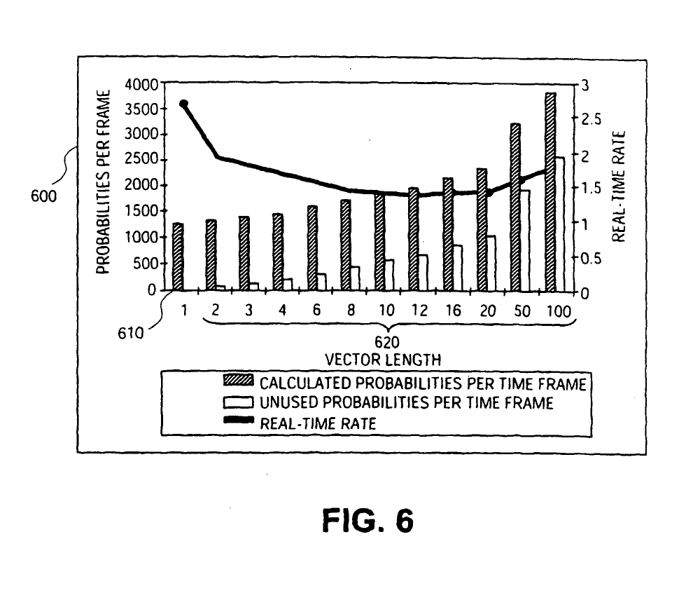

FIG. 6 illustrates example results from using embodiments of the invention having fast calculation speech recognition process 210 that uses SIMD instructions. A vector length of one space, illustrated by 610, corresponds to a traditional approach. A vector length of two through one hundred (2-100), illustrated by 620, illustrates embodiments of the invention.

The example task used for the results 600 is speaker independent, wall street journal, speech recognition with 20,000 words of open vocabulary. One should note that other speech recognition tasks can also be used with embodiments of the invention. The system environment used a 400 megahertz (MHz) Pentium™ III processor. One should note that other systems with alternate processors can also be used with embodiments of the invention. The difference between the different run tests was the length of the calculated observation probability vector. For the above example, the best speed for an invention of the embodiment occurred using a vector length of twelve (12), although more than 34% of calculated probabilities ended up not being used.

The above embodiments can also be stored on a device or machine-readable medium and be read by a machine to perform instructions. The machine-readable medium includes any mechanism that provides (i.e., stores and/or transmits) information in a form readable by a machine (e.g., a computer). For example, a machine-readable medium includes read only memory (ROM); random access memory (RAM); magnetic disk storage media; optical storage media; flash memory devices; electrical, optical, acoustical or other form of propagated signals (e.g., carrier waves, infrared signals, digital signals, etc.). The device or machine-readable medium may include a solid state memory device and/or a rotating magnetic or optical disk. The device or machine-readable medium may be distributed when partitions of instructions have been separated into different machines, such as across an interconnection of computers.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

1. A method comprising:
calculating a plurality of active mixture functions in a vector using single instruction multiple data (SIMD) instructions to process the vector;
storing the vector contents in a memory;
using the vector contents for speech recognition.

2. The method of claim 1, further comprising:
zeroizing contents in the vector.

3. The method of claim 1, calculating the plurality of active mixture functions in the vector using SIMD instructions to process the vector comprises calculating each one of the plurality of active mixture components simultaneously for successive frames.

4. The method of claim 1, wherein the memory is one of a hardware cache memory and a software allocated cache memory.

5. The method of claim 1, the vector contents comprising acoustic probabilities.

6. The method of claim 1, wherein the SIMD instructions also comprise one of streamlining SIMD extension (SSE) instructions and SSE 2 instructions.

7. An apparatus comprising a machine-readable medium containing instructions which, when executed by a machine, cause the machine to perform operations comprising:
determining a plurality of active mixture functions in a vector using single instruction multiple data (SIMD) instructions to process the vector;
storing the vector contents in a memory;
using the vector contents for speech recognition.

8. The apparatus of claim 7, further containing instructions which, when executed by a machine, cause the machine to perform operations including:
zeroizing contents in the vector.

9. The apparatus of claim 7, the determining the plurality of active mixture functions in a vector using SIMD instructions to process the vector instruction further causes the machine to perform operations including:
determining each one of the plurality of active mixture components simultaneously for successive frames.

10. The apparatus of claim 7, wherein the memory is one of a hardware cache memory and a software allocated cache memory.

11. The apparatus of claim 7, the vector contents including acoustic probabilities.

12. The apparatus of claim 7, wherein the SIMD instructions also include one of streamlining SIMD extension (SSE) instructions and SSE 2 instructions.

13. An apparatus comprising:
a processor;
a memory coupled to the processor; and
a fast speech recognition process coupled to the processor and the cache memory, the fast speech recognition process using single instruction multiple data (SIMD) instructions to process a vector.

14. The apparatus of claim 13, the vector comprising a plurality of active mixture component probabilities.

15. The apparatus of claim 13, wherein the fast speech process calculates all of the plurality of active mixture components at once for successive frames.

16. The apparatus of claim 13, wherein the vector has a length between 2 and 100.

17. The apparatus of claim 13, wherein the SIMD instructions also comprise one of streamlining SIMD extension (SSE) instructions and SSE 2 instructions.

18. The apparatus of claim 13, wherein the memory is one of a hardware cache memory and a software allocated cache memory.

19. A system comprising:
a processor having a memory;
a north bridge coupled to the processor;
a main memory coupled to the north bridge;
a south bridge coupled to processor;
a first audio component coupled to the processor;
a second audio component coupled to the processor; and
a fast speech recognition process coupled to the processor, the fast speech recognition process using single instruction multiple data (SIMD) instructions to process a vector.

20. The system of claim 19, the vector including a plurality of active mixture components.

21. The system of claim 19, wherein the fast speech process calculates all of the plurality of active mixture components at once for successive frames.

22. The system of claim 19, wherein the vector has a length between 2 and 100.

23. The system of claim 19, the first audio component performs audio output.

24. The system of claim 19, the second audio component performs audio input.

25. The system of claim 19, wherein the SIMD instructions also include one of streamlining SIMD extension (SSE) instructions and SSE 2 instructions.

26. The system of claim 19, wherein the memory is one of a hardware cache memory and a software allocated cache memory.
